(19) United States
(12) Patent Application Publication
(10) Pub. No.: US 2023/0176542 A1
(43) Pub. Date: Jun. 8, 2023

(54) METHOD AND DEVICE FOR MONITORING PRODUCTION EQUIPMENT AND STORAGE MEDIUM

(71) Applicant: CHANGXIN MEMORY TECHNOLOGIES, INC., Hefei City (CN)

(72) Inventor: Shanshan HUA, Hefei City (CN)

(73) Assignee: CHANGXIN MEMORY TECHNOLOGIES, INC., Hefei City (CN)

(21) Appl. No.: 17/807,862

(22) Filed: Jun. 20, 2022

(30) Foreign Application Priority Data
Dec. 8, 2021 (CN) 202111492911.7

(51) Int. Cl. G05B 19/4063

(52) U.S. Cl. CPC G05B 19/4063; G05B 2219/37001

(57) ABSTRACT

A method and device for monitoring production equipment and a storage medium includes: a measurement result of production equipment to be monitored is acquired; the measurement result of the production equipment to be monitored is evaluated on at least one evaluation dimension to obtain an evaluation result on each evaluation dimension; and a production state of the production equipment to be monitored is determined based on the evaluation result on the at least one evaluation dimension. The production state includes a normal state and an abnormal state. The at least one evaluation dimension includes at least one of a process level of products, a statistical significance of products or a distribution trend of products.

### CROSS-REFERENCE TO RELATED APPLICATIONS

This application claims priority to Chinese Patent Application No. 202111492911.7 filed on Dec. 08, 2021, the disclosure of which is hereby incorporated by reference in its entirety.

### BACKGROUND

Processes for manufacturing a product such as a semiconductor wafer are quite complicated, mainly including exposure, etching, ion implantation, thin film deposition, chemical mechanical polishing, and so on. Practical manufacturing involves 600 to 1,000 steps and hundreds of measurement parameters to be monitored.

According to a conventional method, an engineer with a professional statistics background needs to manually compare performance of equipment under specific parameters and judge differences, thereby determining the stability of a process level of a production line. Such a method is time-consuming and labor-consuming. Moreover, the stability of the process level of the production line is the basis of ensuring the product yield. However, in the conventional method, analysis is started after the occurrence of an abnormal that has affects the product to a certain extent. Therefore, it is impossible to avoid a potential risk of the production line in advance.

### SUMMARY

Embodiments of the disclosure relate to the technical field of product manufacturing process quality control, and relate, but not limited, to a method and device for monitoring production equipment and a storage medium.

In view of this, the embodiments of the disclosure provide a method for monitoring production equipment, a monitoring device, and apparatus, and a storage medium.

According to a first aspect, an embodiment of the disclosure provides a method for monitoring production equipment, which may be applied to a monitoring device and include that: a measurement result of production equipment to be monitored is acquired; the measurement result of the production equipment to be monitored is evaluated on at least one evaluation dimension to obtain an evaluation result on each evaluation dimension; and a production state of the production equipment to be monitored is determined based on the evaluation result on the at least one evaluation dimension. The production state includes a normal state and an abnormal state. The at least one evaluation dimension includes at least one of a process level of products, a statistical significance of products or a distribution trend of products.

According to a second aspect, an embodiment of the disclosure provides a device for monitoring production equipment, which includes a memory and a processor. The memory stores a computer program capable of running in the processor. The processor executes the computer program to implement the steps in the method.

According to a third aspect, an embodiment of the disclosure provides a computer-readable storage medium having stored therein a computer program which is executed by a processor to implement the steps in the method.

### BRIEF DESCRIPTION OF THE DRAWINGS

FIG. 1 is a flowchart of a method for monitoring production equipment according to an embodiment of the disclosure.

FIG. 2 is a flowchart of another method for monitoring production equipment according to an embodiment of the disclosure.

FIG. 3 is a flowchart of another method for monitoring production equipment according to an embodiment of the disclosure.

FIG. 4A is a flowchart of another method for monitoring production equipment according to an embodiment of the disclosure.

FIG. 4B is a flowchart of evaluating a chamber to be monitored on an evaluation dimension about a statistical significance of products according to an embodiment of the disclosure.

FIG. 5 is a structure diagram of an apparatus for monitoring production equipment according to an embodiment of the disclosure.

FIG. 6 is a schematic diagram of a hardware entity of a monitoring device according to an embodiment of the disclosure.

### DETAILED DESCRIPTION

In order to make the objectives, technical solutions and advantages of the disclosure clearer, the technical solutions of the disclosure will further be described below in combination with the drawings and embodiments in detail. The described embodiments should not be considered as limits to the disclosure. All other embodiments obtained by those of ordinary skill in the art without creative work shall fall within the scope of protection of the disclosure.

“Some embodiments” involved in the following descriptions describes a subset of all possible embodiments. However, it can be understood that “some embodiments” may be the same or different subsets of all the possible embodiments and may be combined without conflicts.

The following descriptions are additionally made in the presence of descriptions like “first/second” in the disclosure. Term “first/second/third” involved in the following descriptions is only for distinguishing similar objects, and does not represent a specific sequence of the objects. It can be understood that “first/second/third” may be interchanged to specific sequences or orders if allowed to implement the embodiments of the disclosure described herein in sequences except the illustrated or described ones.

Unless otherwise defined, all technical and scientific terms used herein have the same meanings as commonly understood by those skilled in the art of the disclosure. Terms used in the disclosure are only adopted to describe the embodiments of the disclosure and not intended to limit the disclosure.

The technical solutions of the disclosure will further be elaborated below in combination with the drawings and the embodiments.

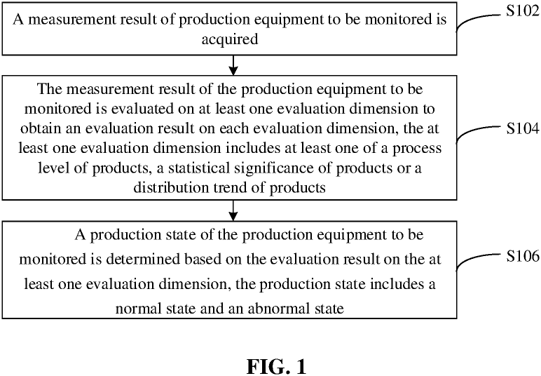

An embodiment of the disclosure provides a method for monitoring production equipment. The method is applied to a monitoring device. As shown in FIG. 1, the method includes the following operations.

At S102, a measurement result of production equipment to be monitored is acquired.

Here, the production equipment to be monitored may be determined according to a produced product and a procedure. The produced product may include, but not limited to, a wafer, a battery, an engine, a tire, a blower, etc. For example, the production equipment to be monitored may be an ion implanter when the produced product is a wafer and the procedure is ion implantation. For another example, the production equipment to be monitored may be an agitation tank when the produced product is a battery and the procedure is mixing.

The measurement result refers to a measurement result of a parameter needing to be measured when the produced product is produced by the production equipment to be monitored. For example, when ion implantation is performed by an ion implanter for a wafer, the parameter needing to be measured may be an implantation depth, a content of an implanted element, etc., and the measurement result may be a measured value of the implantation depth or a measured value of the content of the implanted element. For another example, when mixing is performed by an agitation tank for a battery, the parameter needing to be measured may include a moisture content, a density, etc., and the measurement result may be a measured value of the moisture content or a measured value of the density.

When the produced product is a wafer, the measurement result may further include a measurement result corresponding to a measurement parameter such as a line width (e.g., a line width of a source/drain pattern and a line width of a shallow trench isolation pattern) and a film thickness (e.g., a thickness of a dielectric layer and a thickness of a conductive layer).

In some embodiments, after S102, the method further includes that: the acquired measurement result of the production equipment to be monitored is filtered to remove incomplete data and data of a test stage, and the filtered measurement result is evaluated, so as to reduce influences on the evaluation result.

At S104, the measurement result of the production equipment to be monitored is evaluated on at least one evaluation dimension to obtain an evaluation result on each evaluation dimension, the at least one evaluation dimension at least includes one of a process level of products, a statistical significance of products, and a distribution trend of products.

Here, the measurement result may be a measurement result of the production equipment to be monitored for the same product under the same process parameter. The at least one evaluation dimension may include one evaluation dimension, two evaluation dimensions, and three evaluation dimensions. Different evaluation dimensions may be combined freely during implementation.

The evaluation dimension about the process level of products is configured to evaluate stability of a production process of a product. For example, the process level of products may be evaluated by a process capability index (

$$\left({C}_{p k}\right) .$$

). Here, the process capability index is configured to represent a degree that a process capability satisfies a technical standard (e.g., a specification and a tolerance). An expression of

$${C}_{p k}$$

is as follows.

$${C}_{p k} \text{=Min} \left[\left(\text{USL-} \overline{\text{X}}\right) / 3 σ , \left(\overline{\text{X}} - \text{LSL}\right) / 3 σ\right]$$

Where USL represents a specification upper limit of a measurement parameter corresponding to the measurement result. X represents an average value of the measurement result. σ represents a standard deviation of the measurement result. LSL represents a specification lower limit of the measurement parameter corresponding to the measurement result. Min represents adopting the smaller in (USL-X̅)/3σ and (X̅-LSL)/3σ

In some embodiments, an upper limit

$$\left({}^{{\overline{C}}_{p k}}\right) {\text{of}}^{{C}_{p k}}$$

may be set. A

$${C}_{p k}$$

value of the measurement result of the production equipment to be monitored is compared with

$${\overline{C}}_{p k}$$

to evaluate the stability of the production process of the product. For example, if the

$${C}_{p k}$$

value of the measurement result is greater than

$${\overline{C}}_{p k} ,$$

, it indicates that an evaluation result on the evaluation dimension about the process level of products is that the stability of the production equipment to be monitored is relatively high, recorded as “Match”. If the

$${C}_{p k}$$

value of the measurement result is less than or equal to

$${\overline{C}}_{p k}$$

, it indicates that the evaluation result on the evaluation dimension about the process level of products is that the stability of the production equipment to be monitored is relatively low with an abnormal risk, recorded as “Mismatch”.

The evaluation dimension about the statistical significance of products is configured to evaluate a difference between production equipment in statistical significance in the production process of the product. For example, a difference between the production equipment in statistical significance for the same product under the same process parameter may be evaluated by hypothesis testing based on a P-value.

In some embodiments, reference equipment may be selected, and a significance level of the P-value may be set (e.g., 0.05). The reference equipment may be production equipment of which a measurement result is closest to a target value of the measurement parameter. A difference between the production equipment to be monitored and the reference equipment in statistical significance is judged by hypothesis testing. When the P-value is less than or equal to the significance level 0.05, it indicates that an evaluation result on the evaluation dimension about the statistical significance of products is that the difference of the production equipment to be monitored in statistical significance is significant, recorded as “Mismatch”. When the P-value is greater than the significance level 0.05, it indicates that the evaluation result on the evaluation dimension about the statistical significance of products is that the difference of the production equipment to be monitored in statistical significance is insignificant, recorded as “Mismatch”. In some embodiments, different hypothesis tests may be selected according to whether the measurement result of the production equipment to be monitored satisfies a normal distribution and is equal to a measurement result of the reference equipment in variance.

The evaluation dimension about the distribution trend of products is configured to evaluate a difference between production equipment in distribution trend in the production process of the product. For example, an upper quantile and lower quantile of the measurement result of the production equipment to be monitored may be compared with an upper quantile and lower quantile of a measurement result of another production equipment to evaluate a difference of the measurement result of the production equipment to be monitored in distribution trend.

In some embodiments, when the upper quantile of the measurement result of the production equipment to be monitored is less than a maximum upper quantile of a measurement result of the other production equipment, and the lower quantile of the measurement result of the production equipment to be monitored is greater than a minimum lower quantile of the measurement result of the other production equipment, it indicates that an evaluation result on the evaluation dimension about the distribution trend of products is that the difference of the measurement result of the production equipment to be monitored in distribution trend is insignificant, recorded as “Match”, otherwise the evaluation result on the evaluation dimension about the distribution trend of products is that the difference of the measurement result of the production equipment to be monitored in distribution trend is significant, recorded as “Mismatch”.

In some embodiments, before the implementation of S104, the method further includes the following operations.

At S103, a target group the production equipment to be monitored belongs to is determined.

Correspondingly, the implementation of S104 may include the following three conditions.

A first condition: it is determined that the at least one evaluation dimension is the process level of products in a case that the target group only includes the production equipment to be monitored.

A second condition: it is determined, in a case that the target group includes one piece of production equipment other than the production equipment to be monitored, that the at least one evaluation dimension is one of: the process level of products; or the process level of products and the statistical significance of products.

Here, a piece of production equipment other than the production equipment to be monitored may be determined as reference equipment for evaluation when the evaluation dimension is the evaluation dimension about the statistical significance of products.

A third condition: it is determined, in a case that the target group includes at least two pieces of production equipment other than the production equipment to be monitored, that the at least one evaluation dimension is one of: the process level of products; or the process level of products and the statistical significance of products, or the process level of products, the statistical significance of products and the distribution trend of products.

Here, a piece of production equipment closest to the target value of the measurement parameter other than the production equipment to be monitored may be selected as reference equipment for evaluation when the evaluation dimension is the evaluation dimension about the statistical significance of products. When the evaluation dimension is the evaluation dimension about the distribution trend of products, a maximum upper quantile and minimum lower quantile of a measurement result of another production equipment other than the production equipment to be monitored may be determined, and an upper quantile and lower quantile of the production equipment to be monitored are compared with the maximum upper quantile and the minimum lower quantile to perform the evaluation.

In some embodiments, the implementation of the operation in S103 that “a target group the production equipment to be monitored belongs to is determined” may include the following operations.

At S1031, a measurement result set is acquired, the measurement result set includes measurement results of products produced by each piece of production equipment on a production line in a production state.

Here, the measurement result set may be determined according to a range of production equipment needing to be evaluated. For example, when all production equipment needs to be evaluated, the measurement result set may include measurement results obtained by each piece of production equipment corresponding to different products on all production lines in production states. When part of production equipment needs to be evaluated, the measurement result set may include measurement results corresponding to part of production lines corresponding to the part of production equipment during the production of different products.

At S1032, the measurement results corresponding to the same production equipment and the same process parameter are grouped into one group.

Here, descriptions are made taking the condition that the produced product is a wafer as an example. The wafer may include different types. A process for producing wafers of the same type includes exposure, etching, ion implantation, thin film deposition, chemical mechanical polishing, and other procedures. For the production in the same procedure, at least one (i.e., one, two, or at least two) piece of production equipment may be included. The same process parameter is used for wafers with the same type in the same procedure. In the embodiment of the disclosure, measurement results corresponding to the same production equipment and the same process parameter are grouped into one group. That is, measurement results obtained by the same production equipment under the same process parameter for wafers with the same type in the same procedure are grouped into one group. For example, for wafers with type A, measurement results obtained by the same ion implanter under the same process parameter in an ion implantation procedure are grouped into one group.

In some embodiments, a piece of production equipment may include at least one chamber. Measurement results corresponding to the same chamber and the same process parameter may be grouped into one group.

At S1033, the target group the production equipment to be monitored belongs to is determined.

Here, a group the production equipment to be monitored belongs to is selected as the target group.

At S106, a production state of the production equipment to be monitored is determined based on the evaluation result on the at least one evaluation dimension, the production state includes a normal state and an abnormal state.

Here, the at least one evaluation dimension includes one, two or three evaluation dimensions.

When only one evaluation dimension is used for evaluation, if the evaluation result is “Mismatch”, it indicates that the production state of the production equipment to be monitored is the abnormal state. If the evaluation result is “Match”, it indicates that the production state of the production equipment to be monitored is the normal state.

In some embodiments, the production state of the production equipment to be monitored may be determined based on evaluation results on at least two evaluation dimensions.

Correspondingly, the implementation of S106 may include the following operations.

At S1061, a difference score of the production equipment to be monitored is determined based on the evaluation result on the at least one evaluation dimension.

Here, different scores may be set for the evaluation result on each evaluation dimension. For example, the score is 0 when the evaluation result is “Match”. The score is 1 when the evaluation result is “Mismatch”. Different weights are set for each evaluation dimension to determine the difference score of the production equipment to be monitored.

At S1062, it is determined that the production state of the production equipment to be monitored is an abnormal state in a case that the difference score is greater than a fourth preset threshold.

Here, the fourth preset threshold may be determined according to scores set for the evaluation result on each evaluation dimension. For example, the fourth preset threshold is 0 if it is set that the score is 0 in a case that the evaluation result on each evaluation dimension is “Match” and the score is 1 in a case that the evaluation result is “Mismatch”. The fourth preset threshold is 1 if it is set that the score is 1 in a case that the evaluation result on each evaluation dimension is “Match” and the score is 2 in a case that the evaluation result is “Mismatch”.

At S1063, it is determined that the production state of the production equipment to be monitored is a normal state in a case that the difference score is equal to the fourth preset threshold.

It is to be noted that the method is also applicable to the condition of using only one evaluation dimension for evaluation. In such case, a weight of the evaluation dimension is 1.

In some embodiments, the implementation of S1061 may further include the following operations.

At S1611, a weight of each evaluation dimension is acquired.

Here, the weights of each evaluation dimension may be

$${}^{{\text{w}}_{1}} , {}^{{\text{w}}_{2}} , {\text{and}}^{{\text{w}}_{3}} ,$$

where

$${\text{w}}_{1} , {\text{w}}_{2} , {\text{w}}_{3} ∈ \text{R} \left(0 , 1\right) .$$

During implementation, a practical product yield may be statistically obtained when the evaluation result on each evaluation dimension is “Mismatch”. If the practical product yield is higher, the weight of the evaluation dimension may be lower. Weights of different evaluation dimensions may be set according to the above-mentioned method.

At S1612, it is set that a score is 1 in case of determining, by use of each evaluation dimension, that the production state of the production equipment to be monitored is an abnormal state, otherwise is 0.

Here, when the evaluation result on each evaluation dimension is “Mismatch”, the production state of the production equipment to be monitored is an abnormal state, and the score is 1. When the evaluation result is “Match”, the production state of the production equipment to be monitored is a normal state, and the score is 0.

At S1613, the difference score of the production equipment to be monitored is determined, the difference score is equal to an accumulated sum of a product of the weight of each evaluation dimension and a judgment result score corresponding to the evaluation dimension.

Here, the judgment result score refers to a score corresponding to a judgment that the production state of the production equipment to be monitored is a normal state or an abnormal state according to the evaluation result on each evaluation dimension. An expression of the difference score Score is as follows.

$${\text{Score= w}}_{1} * {\text{V}}_{1} {\text{+ w}}_{2} * {\text{V}}_{2} + {\text{w}}_{3} * {\text{V}}_{3} , {\text{where V}}_{1} , {\text{V}}_{2} {\text{and V}}_{3}$$

result scores under three evaluation dimensions respectively.

For example, if a judgment result score under the evaluation dimension about the process level of products is 1, a judgment result score under the evaluation dimension about the statistical significance of products is 0, and a judgment result score under the evaluation dimension about the distribution trend of products is 0, ^{w1}=0.2, ^{w2}=0.3, and ^{w3}=0.5, then the difference score Score=0.2*1+0.3*0+0.5*0=0.2.

Based on S1062 and S1063, since the score is 0 when the evaluation result on each evaluation dimension is “Match”, otherwise is 1, the fourth preset threshold may be 0. In addition, since the calculated difference score Score is higher than 0, it may be determined that the production state of the production equipment to be monitored is an abnormal state.

In the embodiment of the disclosure, the measurement result of the production equipment to be monitored is acquired, then the measurement result of the production equipment to be monitored is evaluated on the at least one evaluation dimension to obtain the evaluation result on each evaluation dimension, and the production state of the production equipment to be monitored is finally determined based on the evaluation result on the at least one evaluation dimension. The method is applied to the monitoring device and performed by the monitoring device, so that the performance of the production equipment is evaluated automatically on multiple dimensions, and the production state of the production equipment is judged intelligently. As such, the stability of the production line is improved, the labor cost in exception inspection is reduced, meanwhile, a potential risk of the production line is avoided in advance, and a mismatch ratio of the production line and a reject ratio of a product are reduced.

In some embodiments, the evaluation dimension includes the process level of products. Correspondingly, the implementation of the operation in S104 that “the measurement result of the production equipment to be monitored is evaluated on at least one evaluation dimension to obtain an evaluation result on each evaluation dimension” includes the following operations.

At S1041, a parameter value of the process level is determined based on the measurement result of the production equipment to be monitored.

Here, the parameter value may be a

$${C}_{p k}$$

value of the measurement result of the production equipment to be monitored. The measurement result is a measurement result of the production equipment to be monitored for the same product under the same process parameter.

At S1042, the parameter value of the process level is compared with a first preset threshold to obtain an evaluation result on the dimension about the process level of products.

Here, the first preset threshold may be determined according to an importance of the measurement parameter corresponding to the measurement result. For example, the first preset threshold may be set to be 1.67 for a measurement parameter corresponding to a relatively high importance. The first preset threshold may be set to be 1.33 for a measurement parameter corresponding to a general importance. If the first preset thresholds, i.e., the

$${C}_{p k}$$

value, is higher, a reject ratio of a product is lower. References are made to Table 1.

TABLE 1

| Cₚₖ | Qualified rate | Reject ratio (ppm) |
|---|---|---|
| 0.67 | 95.45% | 44431 |
| 1 | 99.73% | 2700 |
| 1.33 | 99.994% | 66 |
| 1.67 | 99.9999% | 0.54 |
| 2 | 99.9999998% | 0.002 |

In some embodiments, when the parameter value of the process level is greater than the first preset threshold, the evaluation result on the dimension about the process level of products is that the stability of the production equipment to be monitored is relatively high, recorded as “Match”. When the parameter value of the process level is less than or equal to the first preset threshold, the evaluation result on the dimension about the process level of products is that the stability of the production equipment to be monitored is relatively low with an exceptional risk, recorded as “Mismatch”.

Correspondingly, the implementation of the operation in S106 that “the production state of the production equipment to be monitored is determined based on the evaluation result on the at least one evaluation dimension” includes the following operation.

At S106a, it is determined that the production state of the production equipment to be monitored is an abnormal state in a case that the parameter value of the process level is less than or equal to the first preset threshold.

That is, the production state of the production equipment to be monitored is an abnormal state when the evaluation result on the dimension about the process level of products is that the stability of the production equipment to be monitored is relatively low with an exceptional risk.

In some embodiments, the evaluation dimension includes the statistical significance of products. Correspondingly, the implementation of the operation in S104 that “the measurement result of the production equipment to be monitored is evaluated on at least one evaluation dimension to obtain an evaluation result on each evaluation dimension” includes the following operations.

At S104a, a measurement result of the production equipment to be monitored and a measurement result of reference equipment are acquired.

Here, the reference equipment may be production equipment of which a measurement result is closest to a target value of the measurement parameter. The production equipment may be one of the same other equipment on the production line, or equipment outside the production line.

In some embodiments, before the implementation of S104a, the following operations are further included.

At S103a, a target group the production equipment to be monitored belongs to is determined.

Here, S103a may refer to S103.

At S103b, production equipment in the target group except the production equipment to be monitored is determined as a reference equipment set.

At S103c, production equipment of which an average value of a measurement result satisfies a condition relative to a preset target value in the reference equipment set is determined as reference equipment.

Here, the preset target value may be a target value of a measurement parameter corresponding to the measurement result. In some embodiments, the condition may be that the average value of the measurement result is closest to the preset target value. That is, the production equipment of which the average value of the measurement result is closest to the preset target value in the reference equipment set is determined as reference equipment.

At S104b, whether the measurement result of the production equipment to be monitored satisfies a normal distribution and the measurement result of the reference equipment satisfies the normal distribution are judged respectively by use of a first hypothesis testing method.

Here, the normal distribution is also referred to as “normally distributed” or Gaussian distribution. A curve of the normal distribution is shaped like a clock with two lower ends and a higher middle, and is bilaterally symmetric. The normal distribution curve is often referred to as a clock-shaped curve since shaped like a clock.

In some embodiments, the first hypothesis testing method may be Shapiro-Wilk testing, and is used to test whether a measurement result satisfies a normal distribution.

At S104c, in a case that the measurement result of the production equipment to be monitored or the measurement result of the reference equipment does not satisfy the normal distribution, whether a difference between the production equipment to be monitored and the reference equipment is significant is judged by use of a second hypothesis testing method to obtain an evaluation result on the dimension about the statistical significance of products.

Here, the second hypothesis testing method may be Kruskal-Wallis testing. Kruskal-Wallis testing converts data into vector statistics (namely all data is sequenced from small to large data, and a vector of each piece of data is calculated, the vector is a position of each observed value after the data are sequenced in an ascending order). A distribution of the vector statistics is unrelated to an overall distribution, so the overall distribution does not need to satisfy a normal distribution, and furthermore, a measurement result not satisfying a normal distribution may be evaluated.

In some embodiments, whether the difference between the production equipment to be monitored and the reference equipment is significant may be judged by use of a P-value. A statistical result of a Kruskal-Wallis test may be calculated at first. Then, a P-value is calculated according to the statistical result. When the P-value is less than or equal to a significance level (e.g., 0.05), an evaluation result on the dimension about the statistical significance of products is that the difference between the production equipment to be monitored and the reference equipment is significant, recorded as “Mismatch”. Otherwise, the difference between the production equipment to be monitored and the reference equipment is insignificant, recorded as “Match”.

In some embodiments, the implementation of the operation in S104b that “whether the measurement result of the production equipment to be monitored satisfies the normal distribution and whether the measurement result of the reference equipment satisfies the normal distribution are judged respectively by use of the first hypothesis testing method ” may include the following operations.

At S104b1, whether the measurement result of the production equipment to be monitored satisfies the normal distribution and whether the measurement result of the reference equipment satisfies the normal distribution are judged respectively by use of the first hypothesis testing method.

At S14b2, it is determined that the measurement result does not satisfy the normal distribution in a case that a P-value of the first hypothesis testing method is less than or equal to a second preset threshold.

Here, the second preset threshold may be a preset threshold of the significance level. In some embodiments, the second preset threshold may be 0.05. When the first hypothesis testing method is Shapiro-Wilk testing, a statistical result of a Shapiro-Wilk test may be calculated at first, and then a P-value is calculated according to the statistical result. The measurement result does not satisfy the normal distribution when the P-value is less than or equal to 0.05. A numerical value of the second preset threshold is not limited in the embodiment of the disclosure.

At S14b3, it is determined that the measurement result satisfies the normal distribution in a case that the P-value of the first hypothesis testing method is greater than the second preset threshold.

Here, the measurement result satisfies the normal distribution when the second preset threshold is 0.05 and the P-value of the first hypothesis testing method is greater than 0.05.

In some embodiments, the evaluation dimension includes the statistical significance of products. Correspondingly, the implementation of the operation in S104 that “the measurement result of the production equipment to be monitored is evaluated on at least one evaluation dimension to obtain an evaluation result on each evaluation dimension” further includes the following operations.

At S104A, a measurement result of the production equipment to be monitored and a measurement result of reference equipment are acquired.

At S104B, whether the measurement result of the production equipment to be monitored satisfies a normal distribution and the measurement result of the reference equipment satisfies the normal distribution are judged respectively by use of a first hypothesis testing method.

Here, S104A and S104B may refer to S104a and S104b.

At S104C, whether variances of the production equipment to be monitored and the reference equipment are equal is judged by use of a third hypothesis testing method in a case that both the measurement result of the production equipment to be monitored and the measurement result of the reference equipment satisfy the normal distribution.

Here, the third hypothesis testing method may be Levene testing, and is used to detect whether the variances of the production equipment to be monitored and the reference equipment are equal.

At S104D, in a case that the variances are equal, whether the difference between the production equipment to be monitored and the reference equipment is significant is judged by use of a fourth hypothesis testing method to obtain the evaluation result on the dimension about the statistical significance of products.

Here, the fourth hypothesis testing method may be student T testing. Student T testing is two-sample T testing. In some embodiments, whether the difference between the production equipment to be monitored and the reference equipment is significant may be judged by use of a P-value. When the P-value is less than or equal to a significance level (e.g., 0.05), an evaluation result on the dimension about the statistical significance of products is that the difference between the production equipment to be monitored and the reference equipment is significant. Otherwise, the difference between the production equipment to be monitored and the reference equipment is insignificant.

During implementation, an original hypothesis

$${\text{H}}_{0} \text{:} {μ}_{g o l d e n} = {μ}_{2}$$

and an alternative hypothesis

$${\text{H}}_{1} \text{:} {μ}_{g o l d e n} \neq {μ}_{2}$$

may be made.

Statistic

$$t \text{=} \left|{μ}_{g o l d e n} - {μ}_{2}\right| / S E D M ; S E D M \text{=} √ \left({S}_{1}^{2} / {n}_{1} + {S}_{2}^{2} / {n}_{2}\right) .$$

In case of

$$\text{P} \left\{\left|{Y}_{i}\right| > t\right\} > 0.05 ,$$

the original hypothesis is accepted, and the difference between the production equipment to be monitored and the reference equipment is insignificant, recorded as “Match”.

In case of

$$\text{P} \left\{\left|{Y}_{i}\right| > t\right\} ⩽ 0.05 ,$$

the original hypothesis is rejected, and the difference between the production equipment to be monitored and the reference equipment is significant, recorded as “Mismatch”.

$${μ}_{g o l d e n}$$

represents an average value of the measurement result of the reference equipment.

$${μ}_{1}$$

represents an average value of the measurement result of the production equipment to be monitored.

$${S}_{1}$$

represents a standard deviation of the measurement result of the reference equipment.

$${S}_{2}$$

represents a standard deviation of the measurement result of the production equipment to be monitored.

$${n}_{1}$$

represents the number of samples in the measurement result of the reference equipment.

$${n}_{2}$$

represents the number of samples in the measurement result of the production equipment to be monitored.

$${Y}_{i}$$

represents the measurement result of the production equipment to be monitored.

$$\text{P} \left\{\left|{Y}_{i}\right| > t\right\}$$

represents the P-value that

$$\left|{Y}_{i}\right|$$

is greater than the statistic t.

At S104E, in a case that the variances are unequal, whether the difference between the production equipment to be monitored and the reference equipment is significant is judged by use of a fifth hypothesis testing method to obtain the evaluation result on the dimension about the statistical significance of products, the fourth hypothesis testing method is different from the fifth hypothesis testing method.

Here, the fifth hypothesis testing method may be Welch testing. In some embodiments, whether the difference between the production equipment to be monitored and the reference equipment is significant may be judged by use of a P-value. During implementation, a statistical result of a Welch test may be calculated at first. Then, a P-value is calculated according to the statistical result. When the P-value is less than or equal to a significance level (e.g., 0.05), an evaluation result on the dimension about the statistical significance of products is that the difference between the production equipment to be monitored and the reference equipment is significant, recorded as “Mismatch”. Otherwise, the difference between the production equipment to be monitored and the reference equipment is insignificant, recorded as “Match”.

In some embodiments, the implementation of the operation in S104C that “whether the variances of the production equipment to be monitored and the reference equipment are equal is judged by use of a third hypothesis testing method” may include the following operations.

At S14C1, whether the variances of the production equipment to be monitored and the reference equipment are equal is judged by use of the third hypothesis testing method.

At S14C2, it is determined that the measurement results do not satisfy that the variances are equal in a case that a P-value of the third hypothesis testing method is less than or equal to a third preset threshold.

Here, the third preset threshold may be a preset threshold of the significance level. In some embodiments, the third preset threshold may be 0.05. When the third hypothesis testing method is Levene testing, a statistical result of a Levene test may be calculated at first, and then a P-value is calculated according to the statistical result. The variances of the production equipment to be monitored and the reference equipment are unequal when the P-value is less than or equal to 0.05. A numerical value of the third preset threshold is not limited in the embodiment of the disclosure.

At S14C3, it is determined that the measurement results satisfy that the variances are equal in a case that the P-value of the third hypothesis testing method is greater than the third preset threshold.

In some embodiments, the evaluation dimension includes the distribution trend of products. Correspondingly, the implementation of the operation in S104 that “the measurement result of the production equipment to be monitored is evaluated on at least one evaluation dimension to obtain an evaluation result on each evaluation dimension” includes the following operations.

At S141, a upper quantile and a lower quantile of measurement results of the production equipment to be monitored and a upper quantile and a lower quantile of a preset reference equipment set are acquired respectively.

Here, the upper quantile and the lower quantile may be an upper quartile and a lower quartile respectively. Quartiles, also referred to as quarter points, refer to numerical values at three division points after all numerical values in statistics are arranged from small to large values and quartered, and are mostly applied to the drawing of box plots in statistics. Quartiles quarter all data through three points, each portion including 25% of the data. The upper quartile refers to a numerical value at a 75% position. The lower quartile refers to a numerical value at a 25% position.

The reference equipment set may include production equipment in the target group except the production equipment to be monitored, or may be a set of equipment outside the production line.

At S142, a maximum upper quantile and minimum lower quantile corresponding to the preset reference equipment set are determined.

At S143, the upper quantile of the production equipment to be monitored is compared with the maximum upper quantile and the lower quantile of the production equipment to be monitored is compared with the minimum lower quantile respectively to correspondingly obtain a first sub evaluation result and second sub evaluation result on the dimension about the distribution trend of products.

Here, the first sub evaluation result may be a comparison result between the upper quantile of the production equipment to be monitored and the maximum upper quantile. The second sub evaluation result may be a comparison result of the lower quantile of the production equipment to be monitored and the minimum lower quantile.

Correspondingly, the implementation of the operation in S106 that “a production state of the production equipment to be monitored is determined based on the evaluation result on the at least one evaluation dimension” includes the following operation.

S106A, it is determined that the production state of the production equipment to be monitored is a normal state in a case that the upper quantile of the production equipment to be monitored is less than the maximum upper quantile and the lower quantile of the production equipment to be monitored is greater than the minimum lower quantile, otherwise it is determined that the production state of the production equipment to be monitored is an abnormal state.

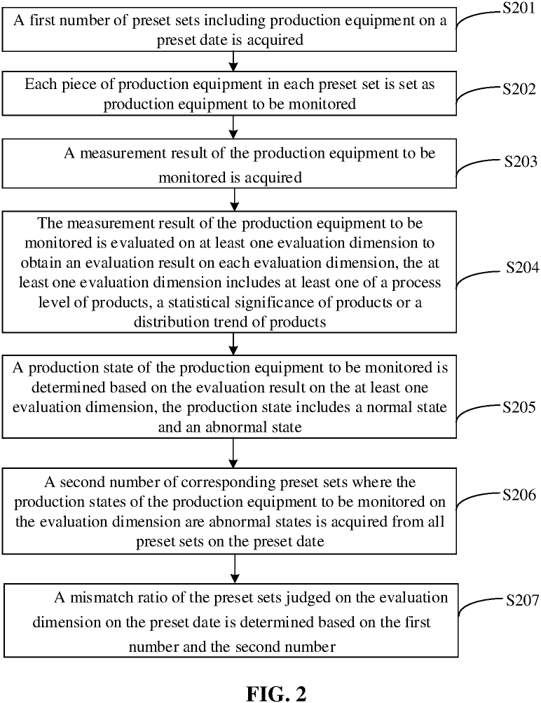

An embodiment of the disclosure also provides a method for monitoring production equipment. As shown in FIG. 2, the method includes the following operations.

At S201, a first number of preset sets including production equipment on a preset date is acquired.

Here, the preset date may be any date when a mismatch ratio of a preset set judged on an evaluation dimension needs to be acquired. Each preset set may correspond to a procedure. A first number of preset sets correspond to a first number of procedures. Each procedure may include at least one piece of production equipment. For example, a process for producing a wafer needs 10 procedures, and the 10 procedures correspond to 10 preset sets. In such case, the first number is 10. One preset set may correspond to an ion implantation procedure. The ion implantation procedure may include 10 ion implanters.

It is to be noted that a setting rule for the preset sets is not limited in the embodiment of the disclosure. The preset sets may be set as required, so as to calculate mismatch ratios of different preset sets.

At S202, each piece of production equipment in each preset set is set as production equipment to be monitored.

At S203, a measurement result of the production equipment to be monitored is acquired.

At S204, the measurement result of the production equipment to be monitored is evaluated on at least one evaluation dimension to obtain an evaluation result on each evaluation dimension, the at least one evaluation dimension includes at least one of a process level of products, a statistical significance of products or a distribution trend of products.

At S205, a production state of the production equipment to be monitored is determined based on the evaluation result on the at least one evaluation dimension, the production state includes a normal state and an abnormal state.

Here, S203 to S205 may refer to S102 to S106.

At S206, a second number of corresponding preset sets where the production state of the production equipment to be monitored on an evaluation dimension is the abnormal state is acquired from all preset sets on the preset date.

Here, there are, for example, totally 10 preset sets, including two preset sets in each of which a production state of at least one piece of production equipment is an abnormal state. In such case, the second number is 2.

At S207, a mismatch ratio of the preset sets judged on the evaluation dimension on the preset date is determined based on the first number and the second number.

Here, the mismatch ratio of the preset sets judged on the evaluation dimension on the preset date is obtained by dividing the second number

$${\text{Z}}_{1}$$

by the first number

$${\text{Z}}_{2}$$

. For example, if the first number is 10, and the second number is 2, the mismatch ratio is 2/10=0.2.

Correspondingly, an expression of the mismatch ratio of the preset sets judged on the evaluation dimension on the preset date is as follows.

Mismatch ratio=Z₁/Z_{2.}

In some embodiments, an upper limit of the mismatch ratio may be set. When a calculated value of the mismatch ratio is greater than the upper limit of the mismatch ratio, an E-mail may be triggered to be sent to a mailbox of a corresponding engineer to request the engineer for cause analysis.

In the embodiment of the disclosure, the first number of the preset sets including production equipment on the preset date and the second number of the corresponding preset sets where the production states of the production equipment to be monitored on the evaluation dimension are abnormal states may be acquired to obtain mismatch ratios of different preset sets judged on the evaluation dimension. Ranges of the preset sets may be changed to implement automatic total-station monitoring of the production line.

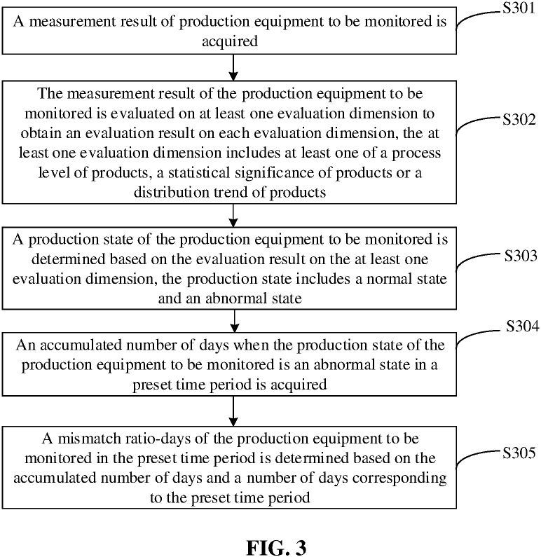

An embodiment of the disclosure also provides a method for monitoring production equipment. As shown in FIG. 3, the method includes the following operations.

S301 to S303 refer to S102 to S106 respectively.

At S304, an accumulated number of days when the production state of the production equipment to be monitored is an abnormal state in a preset time period is acquired.

Here, the preset time period may be set according to time when a mismatch ratio-days of the production equipment to be monitored needs to be calculated. For example, if the mismatch ratio-days of the production equipment to be monitored needs to be calculated in September, the preset time period ranges from 1, September, to 30, September. The accumulated number of days is 3 if the production state of the production equipment to be monitored is an abnormal state in totally three days from 1, September, to 30, September.

At S305, a mismatch ratio-days of the production equipment to be monitored in the preset time period is determined based on the accumulated number of days and a number of days corresponding to the preset time period.

Here, the mismatch ratio-days of the production equipment to be monitored in the preset time period is obtained by dividing the accumulated number of days

$${\text{Y}}_{1}$$

by the number of days

$${\text{Y}}_{2}$$

corresponding to the preset time period. For example, the preset time period ranges from 1, September, to 30, September, the corresponding number of days is 30, and the accumulated number of days is 3. In such case, the mismatch ratio-days of the production equipment to be monitored in the preset time period is 3/30=0.1.

Correspondingly, an expression of the mismatch ratio-days of the production equipment to be monitored in the preset time period is as follows.

Mismatch ratio)-days= Y₁/ Y_{2.}

In some embodiments, an upper limit of the mismatch ratio-days may be set. When a calculated value of the mismatch ratio-days is greater than the upper limit of the mismatch ratio-days, an E-mail may be triggered to be sent to a mailbox of a corresponding engineer to request the engineer for cause analysis.

In the embodiment of the disclosure, the accumulated number of days when the production state of the production equipment to be monitored is an abnormal state in the preset time period may be acquired to obtain mismatch ratios-days of the same production equipment in different time periods, thereby monitoring the stability of the production equipment in a period of time.

An embodiment of the disclosure also provides a method for monitoring production equipment. The method includes the following operations.

At S41, a measurement result set is acquired, the measurement result set including measurement results of products produced by each piece of production equipment on a production line in a production state.

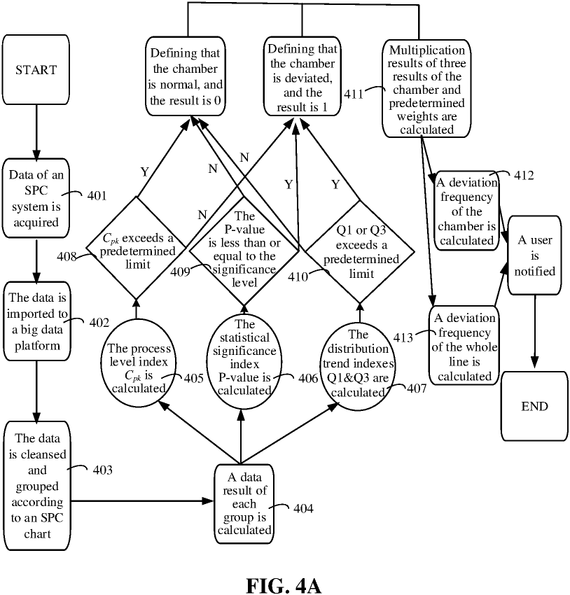

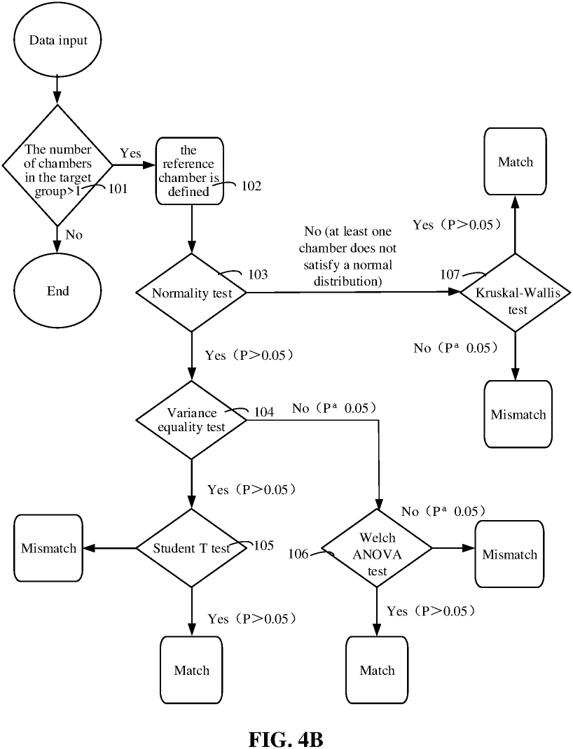

Here, S41 refers to 401 and 402 in FIG. 4A. Data of the measurement result set may be acquired through a Statistics Process Control (SPC) system. Then, the data is imported to a big data platform (e.g., Apache Hadoop). During implementation, some rules may be set up in the SPC system to receive measurement results in a production system such as a Manufacturing Execution System (MES), and then data in the SPC system is imported to the big data platform. At S42, the measurement results corresponding to the same production equipment and the same process parameter are grouped into one group.

Here, S42 corresponds to 403 in FIG. 4A. When the production equipment includes a chamber, measurement results corresponding to the same chamber and the same process parameter may be grouped into one group. In such case, the evaluation of production equipment to be monitored may be converted into the evaluation of a chamber to be monitored. Descriptions will be made below taking the condition that the production equipment to be monitored is a chamber to be monitored as an example. As shown in Table 2, EQP106_CHA, EQP106_CHB, EQP107_CHA, EQP107_CHB, EQP110_CHE, EQP115_CHA, EQP115_CHB and EQP115_CHC correspond to the same procedure, and are the same chambers. Therefore, measurement results obtained during production under the same process parameter may be grouped into one group, recorded as Chart1. Table 2 shows different parameter values corresponding to a measurement result of a thickness of a dielectric layer.

TABLE 2

| Chamber | Target value | Average value | Standard deviation | Number of samples | Maximum | Minimum | Upper quantile | Median | Lower quantile | Specifcation lowerlimit | Specific ation upper limit | Control upper limit | Control lower limit |
|---|---|---|---|---|---|---|---|---|---|---|---|---|---|
| EQP106_CHA | 52.3 | 52.35 | 0.37 | 235 | 53.19 | 51.27 | 52.63 | 52.34 | 52.08 | 51.1 | 53.5 | 52.72 | 52.00 |
| EQP106_CHB | 52.3 | 52.37 | 0.38 | 232 | 53.26 | 51.23 | 52.61 | 52.38 | 52.16 | 51.1 | 53.5 | 52.72 | 52.00 |
| EQP107_CHA | 52.3 | 52.35 | 0.36 | 216 | 53.61 | 51.54 | 52.56 | 52.34 | 52.09 | 51.1 | 53.5 | 52.72 | 52.00 |
| EQP107_CHB | 52.3 | 52.37 | 0.33 | 261 | 53.48 | 51.67 | 52.59 | 52.37 | 52.14 | 51.1 | 53.5 | 52.72 | 52.00 |
| EQP110_CHE | 52.3 | 52.26 | 0.35 | 239 | 53.40 | 51.34 | 52.49 | 52.30 | 52.01 | 51.1 | 53.5 | 52.72 | 52.07 |
| EQP115_CHA | 52.3 | 52.40 | 0.32 | 179 | 53.12 | 51.62 | 52.63 | 52.37 | 52.17 | 51.1 | 53.5 | 52.72 | 52.00 |
| EQP115_CHB | 52.3 | 52.35 | 0.26 | 82 | 53.15 | 51.76 | 52.49 | 52.33 | 52.22 | 51.1 | 53.5 | 52.72 | 52.00 |
| EQP115_CHC | 52.3 | 52.49 | 0.37 | 114 | 53.53 | 51.59 | 52.72 | 52.51 | 52.22 | 51.1 | 53.5 | 52.63 | 52.00 |

In some embodiments, the acquired measurement result may be filtered before grouping to remove incomplete data or data of a test stage.

At S43, a target group a chamber to be monitored belongs to is determined.

Here, S41 to S43 may refer to S1031 to S1033.

When the chamber to be monitored is EQP106_CHB, a target group EQP106_CHB belongs to is Chart1.

At S44, the target group includes at least two chambers other than the chamber to be monitored EQP106_CHB, so a measurement result of the chamber to be monitored is evaluated on three evaluation dimensions, i.e., a process level of products, a statistical significance of products and a distribution trend of products, to obtain an evaluation result on each evaluation dimension.

At S45, a Cₚₖ value of the process level is determined based on the measurement result of the chamber to be monitored.

Here, S45 may refer to S1041, and corresponds to 405 in FIG. 4A. References are made to Cₚₖ values corresponding to different chambers in Table 3. That is, the Cₚₖ values are calculated taking all chambers as chambers to be monitored respectively.

TABLE 3

| Chamber | Average value | Standard deviation | Specification upper limit | Specification lower limit | Parameter value (Cₚₖ) | Cₚₖ_evaluation result |
|---|---|---|---|---|---|---|
| EQP106_CHA | 52.35 | 0.37 | 51.1 | 53.5 | 1.036 | Mismatch |
| EQP106_CHB | 52.37 | 0.38 | 51.1 | 53.5 | 0.9912 | Mismatch |
| EQP107_CHA | 52.35 | 0.36 | 51.1 | 53.5 | 1.0648 | Mismatch |
| EQP107_CHB | 52.37 | 0.33 | 51.1 | 53.5 | 1.1414 | Mismatch |
| EQP110_CHE | 52.26 | 0.35 | 51.1 | 53.5 | 1.1048 | Mismatch |
| EQP115_CHA | 52.4 | 0.32 | 51.1 | 53.5 | 1.1458 | Mismatch |
| EQP115_CHB | 52.35 | 0.26 | 51.1 | 53.5 | 1.4744 | Mismatch |
| EQP115_CHC | 52.49 | 0.37 | 51.1 | 53.5 | 0.9099 | Mismatch |

At S46, the parameter value of the process level is compared with a first preset threshold to obtain the evaluation result on the dimension about the process level of products.

Here, S46 may refer to S1042, and corresponds to 408 in FIG. 4A. Since the thickness of the dielectric layer is a measurement parameter with a relatively high importance, the first preset threshold may be 1.67.

Referring to Table 3, Cₚₖ values of the eight chambers are all less than 1.67. Therefore, evaluation results of the eight chambers on the dimension about the process level are all “Mismatch”.

At S47, it is determined that a production state of the chamber to be monitored is an abnormal state in a case that the parameter value of the process level is less than or equal to the first preset threshold.

Here, S47 may refer to S106a.

Since the evaluation results of the eight chambers on the dimension about the process level are all “Mismatch”, production states of the eight chambers are all abnormal states. That is, there are deviations for the chambers shown in FIG. 4A.

At S48, a chamber in the target group except the chamber to be monitored is determined as a reference chamber set.

Referring to Table 3, the chambers in the target group Chart1 except EQP106_CHB form a reference chamber set. That, the reference chamber set includes EQP106_CHA, EQP110_CHE, EQP107_CHA, EQP107_CHB, EQP115_CHA, EQP115_CHB, and EQP115_CHC.

At S49, a chamber of which an average value of a measurement result satisfies a condition relative to a preset target value in the reference chamber set is determined as a reference chamber. Here, S48 and S49 may refer to S103b and S103c. FIG. 4B is a flowchart of evaluating a chamber to be monitored on an evaluation dimension about a statistical significance of products. S48 and S49 correspond to 101 and 102 in FIG. 4B. When the number of chambers in the target group is larger than 1, evaluation may be performed on the dimension about the statistical significance of products. The reference chamber is defined at first.

Referring to Table 4, a difference refers to an absolute value of a difference between an average value and a target value. It can be seen that EQP110_CHE corresponds to a minimum difference. Therefore, EQP110_CHE is a reference chamber.

TABLE 4

| Chamber | Average value | Target value | Difference |
|---|---|---|---|
| EQP106_CHA | 52.35 | 52.30 | 0.05 |
| EQP106_CHB | 52.37 | 52.30 | 0.07 |
| EQP107_CHA | 52.35 | 52.30 | 0.05 |
| EQP107_CHB | 52.37 | 52.30 | 0.07 |
| EQP110_CHE | 52.26 | 52.30 | 0.04 |
| EQP115_CHA | 52.4 | 52.30 | 0.10 |
| EQP115_CHB | 52.35 | 52.30 | 0.05 |
| EQP115_CHC | 52.49 | 52.30 | 0.19 |

At S50, a measurement result of the reference chamber is acquired.

Here, S50 may refer to S104a.

At S51, whether the measurement result of the chamber to be monitored satisfies a normal distribution and the measurement result of the chamber satisfies the normal distribution are judged respectively by use of a first hypothesis testing method.

Here, S51 corresponds to 103 in FIG. 4B. Both the chamber to be monitored and the reference chamber satisfy the normal distribution when both P-values are greater than 0.05. The chamber to be monitored or the reference chamber does not satisfy the normal distribution when the P-value of at least one chamber is less than or equal to 0.05. The first hypothesis testing method is Shapiro-Wilk testing.

At S52, in a case that the measurement result of the chamber to be monitored or the reference chamber does not satisfy the normal distribution, whether a difference between the chamber to be monitored and the reference chamber is significant is judged by use of a second hypothesis testing method to obtain an evaluation result on the dimension about the statistical significance of products.

Here, S51 and S52 may refer to S104b and S104c. S52 corresponds to 107 in FIG. 4B. That is, the second hypothesis testing method (Kruskal-Wallis testing) is entered when the P-value of at least one chamber is less than or equal to 0.05.

When the P-value is greater than 0.05, the difference between the chamber to be monitored and the reference chamber is significant, recorded as “Mismatch”. When the P-value is less than or equal to 0.05, the difference between the chamber to be monitored and the reference chamber is insignificant, recorded as “Match”.

At S53, whether variances of the chamber to be monitored and the reference chamber are equal is judged by use of a third hypothesis testing method in a case that both the measurement results of the chamber to be monitored and the reference chamber satisfy the normal distribution.

Here, S53 corresponds to 104 in FIG. 4B. The variances of the chamber to be monitored and the reference chamber are equal when the P-value is greater than 0.05. The variances of the chamber to be monitored and the reference chamber are unequal when the P-value is less than or equal to 0.05. The third hypothesis testing method is Levene testing.

At S54, in a case that the variances are equal, whether the difference between the chamber to be monitored and the reference chamber is significant is judged by use of a fourth hypothesis testing method to obtain the evaluation result on the dimension about the statistical significance of products.

Here, S54 corresponds to 105 in FIG. 4B. That is, the fourth hypothesis testing method (student T testing) is entered when the P-value is greater than 0.05. Student T testing is two-sample T testing.

When the P-value is greater than 0.05, the difference between the chamber to be monitored and the reference chamber is significant, recorded as “Mismatch”. When the P-value is less than or equal to 0.05, the difference between the chamber to be monitored and the reference chamber is insignificant, recorded as “Match”.

At S55, in a case that the variances are unequal, whether the difference between the chamber to be monitored and the reference chamber is significant is judged by use of a fifth hypothesis testing method to obtain the evaluation result on the dimension about the statistical significance of products, the fourth hypothesis testing method is different from the fifth hypothesis testing method.

Here, S53 to S55 may refer to S104C to S104E. S55 corresponds to 106 in FIG. 4B. That is, the fifth hypothesis testing method (Welch testing) is entered when the P-value is less than or equal to 0.05.

When the P-value is greater than 0.05, the difference between the chamber to be monitored and the reference chamber is significant, recorded as “Mismatch”. When the P-value is less than or equal to 0.05, the difference between the chamber to be monitored and the reference chamber is insignificant, recorded as “Match”.

S48 to S55 correspond to 406 and 409 in FIG. 4A. Referring to Table 5, it shows evaluation results for different chambers obtained by calculating statistical results using different hypothesis testing methods according to whether measurement results satisfy normal distributions and whether satisfy that variances are equal. It can be seen from Table 5 that, only a P-value of EQP115_CHB other than EQP110_CHE is greater than 0.05, so there are no differences in statistical significance for EQP115_CHB and EQP110_CHE only, the evaluation results thereof are “Match”, and the evaluation results of the other chambers are all “Mismatch”.

TABLE 5

| Chamber | Target value | Average value | Cₚₖ | Number of samples | Average value of the reference chamber | p-value | Statistical result | Hypothesis testing method | Stat_evaluation result |
|---|---|---|---|---|---|---|---|---|---|
| EQP106_CHA | 52.3 | 52.35 | 1.0238 | 235 | 52.26 | 0.0045 | -2.8547 | Student_T | Mismatch |
| EQP106_CHB | 52.3 | 52.37 | 1.0004 | 232 | 52.26 | 0.0005 | 12.0244 | Kruskal_W | Mismatch |
| EQP107_CHA | 52.3 | 52.35 | 1.0615 | 216 | 52.26 | 0.0154 | 5.8686 | Kruskal_W | Mismatch |
| EQP107_CHB | 52.3 | 52.37 | 1.1484 | 261 | 52.26 | 0.0001 | -3.8586 | Student_T | Mismatch |
| EQP110_CHE | 52.3 | 52.26 | 1.1048 | 239 | 52.26 | 0.4280 | 0.9938 | Approach_T | Reference chamber |
| EQP115_CHA | 52.3 | 52.4 | 1.1604 | 179 | 52.26 | 0.0000 | -4.2468 | Student_T | Mismatch |
| EQP115_CHB | 52.3 | 52.35 | 1.4568 | 82 | 52.26 | 0.0534 | 3.7324 | Kruskal_W | Match |
| EQP115_CHC | 52.3 | 52.49 | 0.9104 | 114 | 52.26 | 0.0000 | -5.6369 | Student_T | Mismatch |

Approach T is used to label the reference chamber (chamber closest to the target value). Student_T hypothesis testing is used.

At S56, upper quantiles and lower quantiles of measurement results of the chamber to be monitored and a preset reference chamber set are acquired respectively.

At S57, a maximum upper quantile and minimum lower quantile corresponding to the preset reference chamber set are determined.

At S58, the upper quantile of the chamber to be monitored is compared with the maximum upper quantile and the lower quantile of the chamber to be monitored is compared with the minimum lower quantile respectively to correspondingly obtain a first sub evaluation result and second sub evaluation result on the dimension about the distribution trend of products.

Here, S56 to S58 may refer to S141 to S143.

S59, it is determined that the production state of the chamber to be monitored is a normal state in a case that the upper quantile of the chamber to be monitored is less than the maximum upper quantile and the lower quantile of the chamber to be monitored is greater than the minimum lower quantile, otherwise it is determined that the production state of the chamber to be monitored is an abnormal state.

Here, S59 may refer to S106A.

S56 to S59 correspond to 407 and 410 in FIG. 4A. Referring to Table 6, the table shows an upper quantile and lower quantile of each chamber. The maximum upper quantile in the reference chamber set is 52.72 corresponds to EQP115_CHC, and the minimum lower quantile is 52.01 corresponding to EQP110_CHE. Taking EQP106_CHB as an example, the upper quantile of EQP106_CHB is 52.61, while the lower quantile is 52.16. The upper quantile is less than the maximum upper quantile, and the lower quantile is greater than the minimum lower quantile. Therefore, the evaluation result is “Match”, and the production state is a normal state. Evaluation results of different chambers on the dimension about the distribution trend of products may be obtained according to the above-mentioned method.

TABLE 6

| Chamber | Upper quantile | Median | Lower quantile | Specification lower limit | Specification upper limit | Control upper limit | Control lower limit | Box_evaluation result |
|---|---|---|---|---|---|---|---|---|
| EQP106_CHA | 52.63 | 52.34 | 52.08 | 51.1 | 53.5 | 52.72 | 52.00 | Match |
| EQP106_CHB | 52.61 | 52.38 | 52.16 | 51.1 | 53.5 | 52.72 | 52.00 | Match |
| EQP107_CHA | 52.56 | 52.34 | 52.09 | 51.1 | 53.5 | 52.72 | 52.00 | Match |
| EQP107_CHB | 52.59 | 52.37 | 52.14 | 51.1 | 53.5 | 52.72 | 52.00 | Match |
| EQP110_CHE | 52.49 | 52.30 | 52.01 | 51.1 | 53.5 | 52.72 | 52.07 | Match |
| EQP115_CHA | 52.63 | 52.37 | 52.17 | 51.1 | 53.5 | 52.72 | 52.00 | Match |
| EQP115_CHB | 52.49 | 52.33 | 52.22 | 51.1 | 53.5 | 52.72 | 52.00 | Match |
| EQP115_CHC | 52.72 | 52.51 | 52.22 | 51.1 | 53.5 | 52.63 | 52.00 | Match |

At S60, a weight of each evaluation dimension is acquired.

At S61, it is set that a score is 1 in case of determining, by use of each evaluation dimension, that the production state of the chamber to be monitored is an abnormal state, otherwise is 0.

At S63, a difference score of the chamber to be monitored is determined, the difference score is equal to an accumulated sum of a product of the weight of each evaluation dimension and a judgment result score corresponding to the evaluation dimension.

Here, S60 to S62 may refer to S1611 to S1613.

At S63, it is determined that the production state of the chamber to be monitored is an abnormal state in a case that the difference score is greater than 0.

At S64, it is determined that the production state of the chamber to be monitored is a normal state in a case that the difference score is equal to 0.

Here, S63 to S64 may refer to S1062 to S1063.

S60 to S64 correspond to 411 in FIG. 4A. Referring to Table 7, weights of the evaluation dimension about the process level of products, the evaluation dimension about the statistical significance of products and the evaluation dimension about the distribution trend of products are

$${}^{\text{Cpk\_W1}} , {}^{\text{Stat\_W2}} \text{and} {}^{\text{Box\_W3}}$$

and respectively, and difference scores finally calculated for different chambers are all greater than 0. Therefore, it is obtained that a production state of each chamber is an abnormal state.

TABLE 7

| Chamber | Cₚₖ₋ evaluation result | Stat_evaluation result | Box_evaluation result | Production state | Difference score | Cpk_W₁ | Stat_W₂ | Box_W₃ |
|---|---|---|---|---|---|---|---|---|
| EQP106_CHA | Mismatch | Mismatch | Match | Abnormal | 0.6 | 0.3 | 0.3 | 0.4 |
| EQP106_CHB | Mismatch | Mismatch | Match | Abnormal | 0.6 | 0.3 | 0.3 | 0.4 |
| EQP107_CHA | Mismatch | Mismatch | Match | Abnormal | 0.6 | 0.3 | 0.3 | 0.4 |
| EQP107_CHB | Mismatch | Mismatch | Match | Abnormal | 0.6 | 0.3 | 0.3 | 0.4 |
| EQP110_CHE | Mismatch | Reference chamber | Match | Abnormal | 0.3 | 0.3 | 0.3 | 0.4 |
| EQP115_CHA | Mismatch | Mismatch | Match | Abnormal | 0.6 | 0.3 | 0.3 | 0.4 |
| EQP115_CHB | Mismatch | Match | Match | Abnormal | 0.3 | 0.3 | 0.3 | 0.4 |
| EQP115_CHC | Mismatch | Mismatch | Match | Abnormal | 0.6 | 0.3 | 0.3 | 0.4 |

At S65, a first number of preset sets including chambers on a preset date is acquired.

Here, S65 may refer to S201.

At S66, a second number of corresponding preset sets where the production states of chambers to be monitored on the evaluation dimension are abnormal states in all preset set on the preset date is acquired.

At S67, a mismatch ratio of the preset sets judged on the evaluation dimension on the preset date is determined based on the first number and the second number.

Here, S66 and S67 may refer to S206 and S207.

S65 to S67 correspond to 413 in FIG. 4A.

At S68, an accumulated number of days when the production state of the chamber to be monitored is an abnormal state in a preset time period is acquired.

At S69, a mismatch ratio-days of the chamber to be monitored in the preset time period is determined based on the accumulated number of days and a number of days corresponding to the preset time period.

Here, S68 to S69 may refer to S304 to S305, and correspond to 412 in FIG. 4A.

Based on the above-mentioned embodiments, an embodiment of the disclosure provides an apparatus for monitoring production equipment. Each module of the apparatus, each submodule of each module, each unit of each submodule and each subunit of each unit may be implemented through a monitoring device, or of course, may be implemented through a specific logic circuit. In an implementation process, a processor may be a Central Processing Unit (CPU), a Micro Processing Unit (MPU), a Digital Signal Processor (DSP), a Field-Programmable Gate Array (FPGA), or the like.

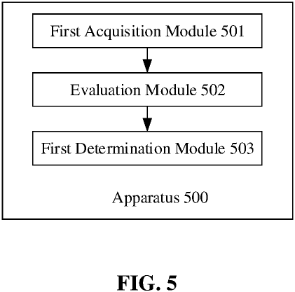

FIG. 5 is a composition structure diagram of an apparatus for monitoring production equipment according to an embodiment of the disclosure. As shown in FIG. 5, the monitoring apparatus 500 includes a first acquisition module 501, an evaluation module 502, and a first determination module 503. The first acquisition module 501 is configured to acquire a measurement result of production equipment to be monitored. The evaluation module 502 is configured to evaluate the measurement result of the production equipment to be monitored on at least one evaluation dimension to obtain an evaluation result on each evaluation dimension. The first determination module 503 is configured to determine a production state of the production equipment to be monitored based on the evaluation result on the at least one evaluation dimension. The production state includes a normal state and an abnormal state. The at least one evaluation dimension includes at least one of a process level of products, a statistical significance of products or a distribution trend of products.

In some embodiments, the apparatus further includes a second determination module, a third determination module, a fourth determination module, and a fifth determination module.

The second determination module is configured to determine a target group the production equipment to be monitored belongs to. The third determination module is configured to determine that the at least one evaluation dimension is the process level of products in a case that the target group only includes the production equipment to be monitored. The fourth determination module is configured to determine, in a case that the target group includes one piece of production equipment other than the production equipment to be monitored, that the at least one evaluation dimension is one of: the process level of products, or the process level of products and the statistical significance of products. The fifth determination module is configured to determine, in a case that the target group includes at least two pieces of production equipment other than the production equipment to be monitored, that the at least one evaluation dimension is one of: the process level of products, or the process level of products and the statistical significance of products, or the process level of products, the statistical significance of products and the distribution trend of products.

In some embodiments, the second determination module includes a first acquisition submodule, a division submodule, and a first determination submodule. The first acquisition submodule is configured to acquire a measurement result set, the measurement result set includes measurement results of products produced by each piece of production equipment on a production line in a production state. The division submodule is configured to group measurement results corresponding to same production equipment and same process parameters into one group. The first determination submodule is configured to determine the target group the production equipment to be monitored belongs to.

In some embodiments, the evaluation dimension includes the process level of products. Correspondingly, the evaluation module 502 includes a second determination submodule and a first comparison submodule. The second determination submodule is configured to determine a parameter value of the process level based on the measurement result of the production equipment to be monitored. The first comparison submodule is configured to compare the parameter value of the process level and a first preset threshold to obtain an evaluation result on a dimension about the process level of products.

Correspondingly, the first determination module 503 includes a third determination submodule, configured to determine that the production state of the production equipment to be monitored is an abnormal state in a case that the parameter value of the process level is less than or equal to the first preset threshold.

In some embodiments, the evaluation dimension includes the statistical significance of products. The evaluation module 502 includes a second acquisition submodule, a first judgment submodule, and a second judgment submodule. The second acquisition submodule is configured to acquire the measurement result of the production equipment to be monitored and a measurement result of reference equipment. The first judgment submodule is configured to judge whether the measurement result of the production equipment to be monitored satisfies a normal distribution and whether the measurement result of the reference equipment satisfies the normal distribution respectively by use of a first hypothesis testing method. The second judgment submodule judges, in a case that the measurement result of the production equipment to be monitored or the measurement result of the reference equipment does not satisfy the normal distribution, whether a difference between the production equipment to be monitored and the reference equipment is significant by use of a second hypothesis testing method to obtain an evaluation result on a dimension about the statistical significance of products.

In some embodiments, the apparatus further includes a sixth determination module, a seventh determination module, and an eighth determination module. The sixth determination module is configured to determine a target group the production equipment to be monitored belongs to. The seventh determination module determines production equipment in the target group except the production equipment to be monitored as a reference equipment set. The eighth determination module determines production equipment of which an average value of a measurement result satisfies a condition relative to a preset target value in the reference equipment set as reference equipment.

In some embodiments, the first judgment submodule includes a first judgment unit, a first determination unit, and a second determination unit. The first judgment unit is configured to judge whether the measurement result of the production equipment to be monitored satisfies the normal distribution and whether the measurement result of the reference equipment satisfies the normal distribution respectively by use of the first hypothesis testing method. The first determination unit is configured to determine that the measurement result does not satisfy the normal distribution in a case that a P-value of the first hypothesis testing method is less than or equal to a second preset threshold. The second determination unit is configured to determine that the measurement result satisfies the normal distribution in a case that the P-value of the first hypothesis testing method is greater than the second preset threshold.

In some embodiments, the evaluation module 502 further includes a third judgment submodule, a fourth judgment submodule, and a fifth judgment submodule.

The third judgment submodule is configured to judge whether variances of the production equipment to be monitored and the reference equipment are equal by use of a third hypothesis testing method in a case that both the measurement result of the production equipment to be monitored and the measurement result of the reference equipment satisfy the normal distribution. The fourth judgment submodule judges, in a case that the variances are equal, whether the difference between the production equipment to be monitored and the reference equipment is significant by use of a fourth hypothesis testing method to obtain the evaluation result on a dimension about the statistical significance of products. The fifth judgment submodule judges, in a case that the variances are unequal, whether the difference between the production equipment to be monitored and the reference equipment is significant by use of a fifth hypothesis testing method to obtain the evaluation result on the dimension about the statistical significance of products, the fourth hypothesis testing method is different from the fifth hypothesis testing method.

In some embodiments, the third judgment submodule includes a second judgment unit, a third determination unit, and a fourth determination unit. The second judgment unit is configured to judge whether the variances of the production equipment to be monitored and the reference equipment are equal by use of the third hypothesis testing method. The third determination unit is configured to determine that the measurement results do not satisfy that the variances are equal in a case that a P-value of the third hypothesis testing method is less than or equal to a third preset threshold. The fourth determination unit is configured to determine that the measurement results satisfy that the variances are equal in a case that the P-value of the third hypothesis testing method is greater than the third preset threshold.

In some embodiments, the evaluation dimension includes the distribution trend of products. The evaluation module 502 further includes a third acquisition submodule, a fourth determination submodule, and a second comparison submodule. The third acquisition submodule is configured to acquire a upper quantile and a lower quantile of measurement results of the production equipment to be monitored and a upper quantile and a lower quantile of a preset reference equipment set respectively. The fourth determination submodule is configured to determine a maximum upper quantile and minimum lower quantile corresponding to the preset reference equipment set. The second comparison submodule is configured to compare the upper quantile of the production equipment to be monitored and the maximum upper quantile and compare the lower quantile of the production equipment to be monitored and the minimum lower quantile respectively to correspondingly obtain a first sub evaluation result and second sub evaluation result on the dimension about a distribution trend of products.

Correspondingly, the first determination module 503 further includes a fifth determination submodule, configured to determine that the production state of the production equipment to be monitored is a normal state in a case that the upper quantile of the production equipment to be monitored is less than the maximum upper quantile and the lower quantile of the production equipment to be monitored is greater than the minimum lower quantile, otherwise determine that the production state of the production equipment to be monitored is an abnormal state.

In some embodiments, the first determination module 503 further includes a sixth determination submodule, a seventh determination submodule, and an eighth determination submodule. The sixth determination submodule is configured to determine a difference score of the production equipment to be monitored based on the evaluation result on the at least one evaluation dimension. The seventh determination submodule is configured to determine that the production state of the production equipment to be monitored is an abnormal state in a case that the difference score is greater than a fourth preset threshold. The eighth determination submodule is configured to determine that the production state of the production equipment to be monitored is a normal state in a case that the difference score is equal to the fourth preset threshold.

In some embodiments, the sixth determination submodule includes an acquisition unit, a setting unit, and a fifth determination unit. The acquisition unit is configured to acquire a weight of each evaluation dimension. The setting unit is configured to set that a score is 1 in case of determining, by use of each evaluation dimension, that the production state of the production equipment to be monitored is an abnormal state, otherwise is 0. The fifth determination unit is configured to determine the difference score of the production equipment to be monitored, the difference score is equal to an accumulated sum of a product of the weight of each evaluation dimension and the score of a judgment result corresponding to the evaluation dimension.

In some embodiments, the apparatus further includes a second acquisition module, a setting module, a ninth determination module, a third acquisition module, and a tenth determination module. The second acquisition module is configured to acquire a first number of preset sets including production equipment on a preset date. The setting module is configured to set each piece of production equipment in each preset set as production equipment to be monitored. The ninth determination module is configured to determine a production state of each piece of production equipment to be monitored. The third acquisition module is configured to acquire a second number of corresponding preset sets where the production state of the production equipment to be monitored on the evaluation dimension is an abnormal state from all preset sets on the preset date. The tenth determination module is configured to determine a mismatch ratio of the preset sets judged on the evaluation dimension on the preset date based on the first number and the second number.

In some embodiments, the apparatus further includes a fourth acquisition module and an eleventh determination module. The fourth acquisition module is configured to acquire an accumulated number of days when the production state of the production equipment to be monitored is an abnormal state in a preset time period. The eleventh determination module is configured to determine a mismatch ratio-days of the production equipment to be monitored in the preset time period based on the accumulated number of days and a number of days corresponding to the preset time period.

The descriptions about the above apparatus embodiment are similar to those about the method embodiment, and beneficial effects similar to those of the method embodiment are achieved. Technical details undisclosed in the apparatus embodiment of the disclosure may be understood with reference to the descriptions about the method embodiment of the disclosure.

It is to be noted that, in the embodiments of the disclosure, the method for monitoring production equipment may be stored in a computer-readable storage medium when implemented in form of a software function module and sold or used as an independent product. Based on such an understanding, the technical solutions of the embodiments of the disclosure substantially or parts making contributions to the related art may be embodied in form of a software product. The computer software product is stored in a storage medium, including a plurality of instructions configured to enable a monitoring device to execute all or part of the method in each embodiment of the disclosure. The storage medium includes various media capable of storing program codes such as a U disk, a mobile hard disk, a Read Only Memory (ROM), a magnetic disk, or an optical disk. Therefore, the embodiments of the disclosure are not limited to any specific hardware and software combination.

Correspondingly, an embodiment of the disclosure provides a monitoring device, which includes a memory and a processor. The memory stores a computer program capable of running in the processor. The processor executes the program to implement the steps in the method for monitoring production equipment provided in the above-mentioned embodiment.

Correspondingly, an embodiment of the disclosure provides a computer-readable storage medium having stored therein a computer program which is executed by a processor to implement the steps in the method for monitoring production equipment in the above-mentioned embodiment.

It is to be pointed out here that the descriptions about the above storage medium and device embodiments are similar to those about the method embodiment, and beneficial effects similar to those of the method embodiment are achieved. Technical details undisclosed in the storage medium and device embodiments of the disclosure are understood with reference to the descriptions about the method embodiment of the disclosure.

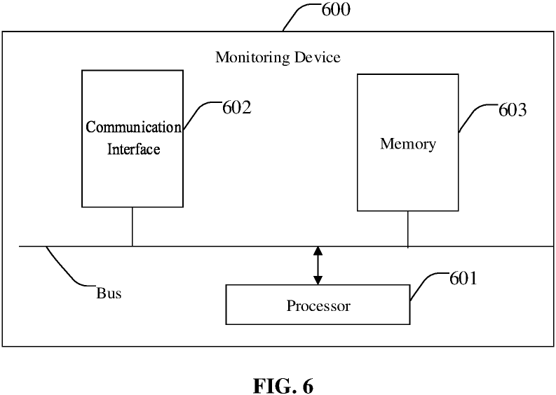

It is to be noted that FIG. 6 is a schematic diagram of a hardware entity of a monitoring device according to an embodiment of the disclosure. As shown in FIG. 6, the hardware entity of the monitoring device 600 includes a processor 601, a communication interface 602, and a memory 603.

The processor 601 usually controls overall operations of the monitoring device 600.

The communication interface 602 may enable the monitoring device 600 to communicate with another platform or electronic device or server through a network.

The memory 603 is configured to store an instruction and application executable for the processor 601, may also cache data (for example, image data and document data) to be processed or having been processed by the processor 601 and each module in the monitoring device 600, and may be implemented through a flash or a Random Access Memory (RAM).

In the embodiments of the disclosure, the measurement result of the production equipment to be monitored is acquired, then the measurement result of the production equipment to be monitored is evaluated on the at least one evaluation dimension to obtain the evaluation result on each evaluation dimension, and the production state of the production equipment to be monitored is finally determined based on the evaluation result on the at least one evaluation dimension. The method is applied to the monitoring device and performed by the monitoring device, so that the performance of the production equipment is evaluated automatically on multiple dimensions, and the production state of the production equipment is judged intelligently. As such, the stability of the production line is improved, the labor cost in exception inspection is reduced, meanwhile, a potential risk of the production line is avoided in advance, and a mismatch ratio of the production line and a reject ratio of a product are reduced.

It is to be understood that “one embodiment” and “an embodiment” mentioned in the whole specification mean that specific features, structures or characteristics related to the embodiment is included in at least one embodiment of the disclosure. Therefore, “in one embodiment” or “in an embodiment” mentioned throughout the specification does not always refer to the same embodiment. In addition, these specific features, structures or characteristics may be combined in one or more embodiments freely as appropriate. It is to be understood that, in each embodiment of the disclosure, the magnitude of the sequence number of each process does not mean an execution sequence and the execution sequence of each process should be determined by its function and an internal logic and should not form any limit to an implementation process of the embodiments of the disclosure. The sequence numbers of the embodiments of the disclosure are adopted not to represent superiority-inferiority of the embodiments but only for description.

It is to be noted that terms “include” and “contain” or any other variant thereof is intended to cover nonexclusive inclusions herein, so that a process, method, object or device including a series of elements not only includes those elements but also includes other elements which are not clearly listed or further includes elements intrinsic to the process, the method, the object or the device. Under the condition of no more limitations, an element defined by the statement “including a/an......” does not exclude existence of the same other elements in a process, method, object or device including the element.

In some embodiments provided by the disclosure, it is to be understood that the disclosed device and method may be implemented in another manner. The device embodiment described above is only schematic. For example, the division of the units is only logic function division, and other division manners may be adopted during practical implementation. For example, multiple units or components may be combined or integrated into another system, or some characteristics may be neglected or not executed. In addition, coupling or direct coupling or communication connection between various displayed or discussed components may be indirect coupling or communication connection, implemented through some interfaces, of the device or the units, and may be electrical and mechanical or adopt other forms.

The units described as separate parts may or may not be physically separated. Parts displayed as units may or may not be physical units, namely located in the same place or distributed to multiple network units. Part of all of the units may be selected according to a practical requirement to achieve the purposes of the solutions of the embodiments. In addition, each function unit in each embodiment of the disclosure may be integrated into a processing unit. Alternatively, each unit may serve as an independent unit. Alternatively, two or more than two units may be integrated into a unit. The integrated unit may be implemented in a hardware form or in form of a hardware and software function unit.

Those of ordinary skill in the art should know that all or part of the steps of the method embodiment may be implemented by related hardware instructed through a program. The program may be stored in a computer-readable storage medium. When the program is executed, the steps of the method embodiment are executed. The storage medium includes various media capable of storing program codes such as a mobile storage device, a ROM, a magnetic disk, or an optical disc. Alternatively, the integrated unit of the disclosure may be stored in a computer-readable storage medium when implemented in form of a software function module and sold or used as an independent product. Based on such an understanding, the technical solutions of the embodiments of the disclosure substantially or parts making contributions to the related art may be embodied in form of a software product. The computer software product is stored in a storage medium, including a plurality of instructions configured to enable a monitoring device to execute all or part of the methods in various embodiments of the disclosure. The storage medium includes various media capable of storing program codes such as a mobile hard disk, a ROM, a magnetic disk, or an optical disc.

The methods disclosed in some method embodiments provided in the disclosure may be freely combined without conflicts to obtain new method embodiments. The characteristics disclosed in some product embodiments provided in the disclosure may be freely combined without conflicts to obtain new product embodiments. The characteristics disclosed in some method or device embodiments provided in the disclosure may be freely combined without conflicts to obtain new method embodiments or device embodiments.

The above is only the implementation mode of the disclosure and not intended to limit the scope of protection of the disclosure. Any variations or replacements apparent to those skilled in the art within the technical scope disclosed by the disclosure shall fall within the scope of protection of the disclosure. Therefore, the scope of protection of the disclosure shall be subject to the scope of protection of the claims.

What is claimed is:

1. A method for monitoring production equipment, applied to a monitoring device and comprising:
acquiring a measurement result of production equipment to be monitored;
evaluating the measurement result of the production equipment to be monitored on at least one evaluation dimension, to obtain an evaluation result on each evaluation dimension; and
determining a production state of the production equipment to be monitored based on the evaluation result on the at least one evaluation dimension,
wherein the production state comprises a normal state and an abnormal state, and the at least one evaluation dimension comprises at least one of a process level of products, a statistical significance of products or a distribution trend of products.

2. The method of claim 1, further comprising:
determining a target group the production equipment to be monitored belongs to;
determining, in a case that the target group only comprises the production equipment to be monitored, that the at least one evaluation dimension is the process level of products;
determining, in a case that the target group comprises one piece of production equipment other than the production equipment to be monitored, that the at least one evaluation dimension is one of:
the process level of products; or
the process level of products and the statistical significance of products; and
determining, in a case that the target group comprises at least two pieces of production equipment other than the production equipment to be monitored, that the at least one evaluation dimension is one of:
the process level of products;
the process level of products and the statistical significance of products; or
the process level of products, the statistical significance of products and the distribution trend of products.

3. The method of claim 2, wherein the determining the target group the production equipment to be monitored belongs to comprises:
acquiring a measurement result set, the measurement result set comprising measurement results of products produced by each piece of production equipment on a production line in a production state;
grouping measurement results corresponding to same production equipment and same process parameters into one group; and
determining the target group the production equipment to be monitored belongs to.

4. The method of claim 1, wherein the evaluation dimension comprises the process level of products,
wherein the evaluating the measurement result of the production equipment to be monitored on the at least one evaluation dimension to obtain the evaluation result on each evaluation dimension comprises:
determining a parameter value of the process level based on the measurement result of the production equipment to be monitored; and
comparing the parameter value of the process level and a first preset threshold to obtain an evaluation result on a dimension about the process level of products;
and wherein the determining the production state of the production equipment to be monitored based on the evaluation result on the at least one evaluation dimension comprises:
determining that the production state of the production equipment to be monitored is an abnormal state in a case that the parameter value of the process level is less than or equal to the first preset threshold.

5. The method of claim 1, wherein the evaluation dimension comprises the statistical significance of products,
and wherein the evaluating the measurement result of the production equipment to be monitored on the at least one evaluation dimension to obtain the evaluation result on each evaluation dimension comprises:
acquiring the measurement result of the production equipment to be monitored and a measurement result of reference equipment;
judging whether the measurement result of the production equipment to be monitored satisfies a normal distribution and whether the measurement result of the reference equipment satisfies the normal distribution, respectively by use of a first hypothesis testing method; and
judging, in a case that the measurement result of the production equipment to be monitored does not satisfy the normal distribution or the measurement result of the reference equipment does not satisfy the normal distribution, whether a difference between the production equipment to be monitored and the reference equipment is significant by use of a second hypothesis testing method to obtain an evaluation result on a dimension about the statistical significance of products.

6. The method of claim 5, further comprising:
determining a target group the production equipment to be monitored belongs to;
determining production equipment in the target group except the production equipment to be monitored as a reference equipment set; and
determining production equipment of which an average value of a measurement result satisfies a condition relative to a preset target value in the reference equipment set as reference equipment.

7. The method of claim 5, wherein the judging whether the measurement result of the production equipment to be monitored satisfies the normal distribution and whether the measurement result of the reference equipment satisfies the normal distribution, respectively by use of the first hypothesis testing method comprises:
judging whether the measurement result of the production equipment to be monitored satisfies the normal distribution and whether the measurement result of the reference equipment satisfies the normal distribution, respectively by use of the first hypothesis testing method;
determining that the measurement result does not satisfy the normal distribution in a case that a Probability-value (P-value) of the first hypothesis testing method is less than or equal to a second preset threshold; and
determining that the measurement result satisfies the normal distribution in a case that the P-value of the first hypothesis testing method is greater than the second preset threshold.

8. The method of claim 5, wherein the evaluating the measurement result of the production equipment to be monitored on the at least one evaluation dimension to obtain the evaluation result on each evaluation dimension further comprises:
judging whether variances of the production equipment to be monitored and the reference equipment are equal by use of a third hypothesis testing method in a case that both the measurement result of the production equipment to be monitored and the measurement result of the reference equipment satisfy the normal distribution;
judging, in a case that the variances are equal, whether a difference between the production equipment to be monitored and the reference equipment is significant by use of a fourth hypothesis testing method to obtain the evaluation result on a dimension about the statistical significance of products; and
judging, in a case that the variances are unequal, whether a difference between the production equipment to be monitored and the reference equipment is significant by use of a fifth hypothesis testing method to obtain the evaluation result on the dimension about the statistical significance of products,
the fourth hypothesis testing method being different from the fifth hypothesis testing method.

9. The method of claim 8, wherein the judging whether the variances of the production equipment to be monitored and the reference equipment are equal by use of the third hypothesis testing method comprises:
judging whether the variances of the production equipment to be monitored and the reference equipment are equal by use of the third hypothesis testing method;
determining that the measurement results do not satisfy that the variances are equal in a case that a Probability-value (P-value) of the third hypothesis testing method is less than or equal to a third preset threshold; and
determining that the measurement results satisfy that the variances are equal in a case that the P-value of the third hypothesis testing method is greater than the third preset threshold.

10. The method of claim 1, wherein the evaluation dimension comprises the distribution trend of products;
the evaluating the measurement result of the production equipment to be monitored on the at least one evaluation dimension to obtain the evaluation result on each evaluation dimension comprises:
acquiring a upper quantile and a lower quantile of the measurement result of the production equipment to be monitored and a upper quantile and a lower quantile of measurement results of a preset reference equipment set,
determining a maximum upper quantile and minimum lower quantile corresponding to the preset reference equipment set, and
comparing the upper quantile of the production equipment to be monitored and the maximum upper quantile and comparing the lower quantile of the production equipment to be monitored and the minimum lower quantile respectively to obtain a first sub evaluation result and second sub evaluation result on a dimension about the distribution trend of products; and
the determining the production state of the production equipment to be monitored based on the evaluation result on the at least one evaluation dimension comprises:
determining that the production state of the production equipment to be monitored is a normal state in a case that the upper quantile of the production equipment to be monitored is less than the maximum upper quantile and the lower quantile of the production equipment to be monitored is greater than the minimum lower quantile, otherwise determining that the production state of the production equipment to be monitored is an abnormal state.

11. The method of claim 1, wherein the determining the production state of the production equipment to be monitored based on the evaluation result on the at least one evaluation dimension comprises:
determining a difference score of the production equipment to be monitored based on the evaluation result on the at least one evaluation dimension;
determining that the production state of the production equipment to be monitored is an abnormal state in a case that the difference score is greater than a fourth preset threshold; and
determining that the production state of the production equipment to be monitored is a normal state in a case that the difference score is equal to the fourth preset threshold.

12. The method of claim 11, wherein the determining the difference score of the production equipment to be monitored based on the evaluation result on the at least one evaluation dimension comprises:
acquiring a weight of each evaluation dimension;
setting that a score is 1 in a case of determining, by use of each evaluation dimension, that the production state of the production equipment to be monitored is an abnormal state, otherwise is 0; and
determining the difference score of the production equipment to be monitored, the difference score being equal to an accumulated sum of a product of the weight of each evaluation dimension and the score of a judgment result corresponding to the evaluation dimension.

13. The method of claim 1, further comprising:
acquiring a first number of preset sets comprising production equipment on a preset date;
setting each piece of production equipment in each preset set as production equipment to be monitored;
determining the production state of each piece of production equipment to be monitored;
acquiring a second number of corresponding preset sets where the production state of the production equipment to be monitored on the evaluation dimension is an abnormal state from all preset sets on the preset date; and
determining a mismatch ratio of the preset sets judged on the evaluation dimension on the preset date based on the first number and the second number.

14. The method of claim 1, further comprising:
acquiring an accumulated number of days when the production state of the production equipment to be monitored is an abnormal state in a preset time period; and
determining a mismatch ratio-days of the production equipment to be monitored in the preset time period based on the accumulated number of days and a number of days corresponding to the preset time period.

15. A device for monitoring production equipment, comprising
a memory for storing a computer program; and
a processor,
wherein the processor is configured to execute the computer program to implement the following operations:
acquiring a measurement result of production equipment to be monitored;
evaluating the measurement result of the production equipment to be monitored on at least one evaluation dimension, to obtain an evaluation result on each evaluation dimension; and
determining a production state of the production equipment to be monitored based on the evaluation result on the at least one evaluation dimension,
wherein the production state comprises a normal state and an abnormal state, and the at least one evaluation dimension comprises at least one of a process level of products, a statistical significance of products or a distribution trend of products.

16. The device of claim 15, wherein the processor is further configured to execute the computer program to:
determine a target group the production equipment to be monitored belongs to;
determine, in a case that the target group only comprises the production equipment to be monitored, that the at least one evaluation dimension is the process level of products;
determine, in a case that the target group comprises one piece of production equipment other than the production equipment to be monitored, that the at least one evaluation dimension is one of:
the process level of products; or
the process level of products and the statistical significance of products; and determine, in a case that the target group comprises at least two pieces of production equipment other than the production equipment to be monitored, that the at least one evaluation dimension is one of:
the process level of products;
the process level of products and the statistical significance of products; or
the process level of products, the statistical significance of products and the distribution trend of products.

17. The device of claim 16, wherein the processor is further configured to execute the computer program to:
acquire a measurement result set, the measurement result set comprising measurement results of products produced by each piece of production equipment on a production line in a production state;
group measurement results corresponding to same production equipment and same process parameters into one group; and
determine the target group the production equipment to be monitored belongs to.

18. The device of claim 15, wherein the evaluation dimension comprises the process level of products, and wherein the processor is further configured to execute the computer program to:
determine a parameter value of the process level based on the measurement result of the production equipment to be monitored;
compare the parameter value of the process level and a first preset threshold to obtain an evaluation result on a dimension about the process level of products; and
determine that the production state of the production equipment to be monitored is an abnormal state in a case that the parameter value of the process level is less than or equal to the first preset threshold.

19. The device of claim 15, wherein the evaluation dimension comprises the statistical significance of products, and wherein the processor is further configured to execute the computer program to:
acquire the measurement result of the production equipment to be monitored and a measurement result of reference equipment;
judge whether the measurement result of the production equipment to be monitored satisfies a normal distribution and whether the measurement result of the reference equipment satisfies the normal distribution, respectively by use of a first hypothesis testing method; and
judge, in a case that the measurement result of the production equipment to be monitored does not satisfy the normal distribution or the measurement result of the reference equipment does not satisfy the normal distribution, whether a difference between the production equipment to be monitored and the reference equipment is significant by use of a second hypothesis testing method to obtain an evaluation result on a dimension about the statistical significance of products.

20. A non-transitory computer-readable storage medium having stored therein a computer program which is executed by a processor to implement the following operations:
acquiring a measurement result of production equipment to be monitored;
evaluating the measurement result of the production equipment to be monitored on at least one evaluation dimension, to obtain an evaluation result on each evaluation dimension; and
determining a production state of the production equipment to be monitored based on the evaluation result on the at least one evaluation dimension,
wherein the production state comprises a normal state and an abnormal state, and the at least one evaluation dimension comprises at least one of a process level of products, a statistical significance of products or a distribution trend of products.
